(19) United States
(12) Patent Application Publication
(10) Pub. No.: US 2025/0266568 A1
(43) Pub. Date: Aug. 21, 2025

(54) POWER STORAGE DEVICE

(71) Applicant: TOYOTA JIDOSHA KABUSHIKI KAISHA, Toyota-shi (JP)

(72) Inventor: Shinya GOITSUKA, Nisshin-shi (JP)

(73) Assignee: TOYOTA JIDOSHA KABUSHIKI KAISHA, Toyota-shi (JP)

(21) Appl. No.: 19/008,811

(22) Filed: Jan. 3, 2025

(30) Foreign Application Priority Data
Feb. 21, 2024 (JP) 2024-024265

(51) Int. Cl. H01M 50/367; H01M 10/613; H01M 10/625; H01M 10/6557; H01M 50/249; H01M 50/289; H01M 50/342

(52) U.S. Cl. CPC H01M 50/367; H01M 10/613; H01M 10/625; H01M 10/6557; H01M 50/249; H01M 50/289; H01M 50/3425

(57) ABSTRACT

A power storage device includes: a first power storage cell and a second power storage cell disposed side by side in a first direction; and a cross member extending along a second direction perpendicular to the first direction and disposed in a gap between the first power storage cell and the second power storage cell. The first power storage cell includes a first side wall portion facing the cross member. The first side wall portion is provided with a first exhaust valve. The cross member is provided with a hollow portion, and is provided with a first opening such that the first opening faces the first side wall portion. The cross member is provided with a communicating portion that allows the hollow portion and a space around the cross member to communicate with each other. The communicating portion is provided at a position not facing the first exhaust valve.

### CROSS REFERENCE TO RELATED APPLICATIONS

This nonprovisional application is based on Japanese Patent Application No. 2024-024265 filed on Feb. 21, 2024 with the Japan Patent Office, the entire contents of which are hereby incorporated by reference.

### BACKGROUND

### Field

The present disclosure relates to a power storage device.

### Description of the Background Art

As a conventional power storage device, Japanese Patent Laying-Open No. 2023-165300 discloses a power storage device including a cross member that partitions a space in a battery case into a plurality of regions, wherein a power storage module is disposed in each of the plurality of regions.

### SUMMARY

Generally, a power storage module includes a plurality of power storage cells each having an exhaust valve, and when one power storage cell generates heat, an emission is discharged from an exhaust valve of the power storage cell having generated the heat. The emission includes a gas, an electrolyte and the like, and if no measures are taken, the emission is accumulated in a region where the power storage module having generated the heat is disposed. As a result, the emission may adhere to the power storage module, which may cause a short circuit of the power storage module.

The present disclosure has been made in view of the above-described problem, and an object of the present disclosure is to provide a power storage device capable of suppressing scattering of an emission discharged from a power storage cell having generated heat.

A power storage device according to the present disclosure includes: a first power storage cell and a second power storage cell spaced apart from each other and disposed side by side in a first direction; and a cross member extending along a second direction perpendicular to the first direction and disposed in a gap between the first power storage cell and the second power storage cell. The first power storage cell includes a first side wall portion facing the cross member. The first side wall portion is provided with a first exhaust valve. The cross member is provided with a hollow portion in a cross section perpendicular to the second direction, and is provided with a first opening such that the first opening faces the first side wall portion. The cross member is provided with a communicating portion that allows the hollow portion and a space around the cross member to communicate with each other. The communicating portion is provided at a position where the communicating portion does not face the first exhaust valve.

According to the above-described configuration, when the first power storage cell generates heat and an emission is discharged from the first exhaust valve, the emission can be introduced into the hollow portion of the cross member through the first opening provided in the cross member to face the first power storage cell. Thus, the emission can be collected inside the cross member (hollow portion). As a result, scattering of the emission discharged from the power storage cell having generated the heat can be suppressed.

In addition, the emission includes a gas, and the gas introduced into the cross member through the first opening is discharged from the communicating portion provided at the position where the communicating portion does not face the first exhaust valve, whereby an excessive increase in internal pressure of the cross member caused by the gas introduced into the cross member through the first opening can be suppressed. Generally, when the internal pressure of the cross member increases excessively, there is a concern that a part of the cross member may be deformed or broken and the gas may be jetted from an unintended location and the emission collected inside the cross member may be blown out. However, since the communicating portion is provided as described above, the excessive increase in internal pressure of the cross member can be suppressed and the above-described blowout of the emission from the unintended location can be suppressed. This also makes it possible to suppress scattering of the emission discharged from the power storage cell having generated the heat.

In the power storage device according to the present disclosure, the first opening may be disposed to face the first exhaust valve.

According to the above-described configuration, the emission is discharged directly to the first opening from the first exhaust valve. Therefore, diffusion of the emission to the surroundings of a power storage module can be suppressed and the emission can be directly introduced into the cross member. Thus, scattering of the emission can be further suppressed.

In the power storage device according to the present disclosure, the second power storage cell may include a second side wall portion facing the cross member. The second side wall portion may be provided with a second exhaust valve. In this case, the cross member may be provided with a second opening such that the second opening faces the second side wall portion.

According to the above-described configuration, when the second power storage cell generates heat and an emission is discharged from the second exhaust valve, the emission can be introduced into the hollow portion of the cross member through the second opening provided in the cross member to face the second power storage cell. Thus, the emission can be collected inside the cross member (hollow portion). As a result, scattering of the emission included in the gas discharged from the power storage cell having generated the heat can be suppressed.

In the power storage device according to the present disclosure, the first opening and the second opening may be covered with a heat insulating member provided to be breakable.

According to the above-described configuration, when the emission is discharged from the first exhaust valve of the first power storage cell, the heat insulating member is broken by the momentum of the discharged emission. Thus, the emission can be introduced into the cross member through the first opening and the emission can be collected inside the cross member. In addition, since the second opening is provided with the heat insulating member, transmission of the heat from the emission introduced through the first opening to the second power storage cell through the second opening can be suppressed. Thus, an increase in temperature of the second power storage cell can be suppressed.

On the other hand, when the emission is discharged from the second exhaust valve of the second power storage cell, the heat insulating member is broken by the momentum of the discharged emission. Thus, the emission can be introduced into the cross member through the second opening and the emission can be collected inside the cross member. In addition, since the first opening is provided with the heat insulating member, transmission of the heat from the emission introduced through the second opening to the first power storage cell through the first opening can be suppressed. Thus, an increase in temperature of the first power storage cell can be suppressed.

In the power storage device according to the present disclosure, the heat insulating member may be provided with an easily breakable portion.

According to the above-described configuration, when the emission is discharged from one power storage cell of the first power storage cell and the second power storage cell, the heat insulating member located on the one power storage cell side can be broken more reliably.

In the power storage device according to the present disclosure, the first opening and the second opening may be disposed to be displaced in a vertical direction perpendicular to the first direction and the second direction, when viewed in the first direction.

According to the above-described configuration, even when the emission is introduced through one opening of the first opening and the second opening, a flow of the emission directly to the other opening can be suppressed.

In the power storage device according to the present disclosure, the communicating portion may be provided above the first exhaust valve in a vertical direction perpendicular to the first direction and the second direction.

According to the above-described configuration, when the gas included in the emission introduced into the cross member through the first opening is discharged from the communicating portion, the gas can be discharged above the first exhaust valve. Thus, blowing of the gas discharged from the communicating portion against the first exhaust valve can be suppressed.

In the power storage device according to the present disclosure, a height of the cross member in the vertical direction may be higher than a height of the first power storage cell and the second power storage cell in the vertical direction. In this case, the communicating portion may be provided above the first power storage cell and the second power storage cell.

According to the above-described configuration, when the gas included in the emission introduced into the cross member through the first opening is discharged from the communicating portion, the gas can be discharged above the first power storage cell and the second power storage cell. Thus, blowing of the gas discharged from the communicating portion against the first power storage cell and the second power storage cell can be suppressed and an increase in temperature of the first power storage cell and the second power storage cell can be suppressed.

In the power storage device according to the present disclosure, the cross member may include an upper wall portion on an upper side in the vertical direction, and the communicating portion may be provided in the upper wall portion.

According to the above-described configuration, when the gas included in the emission introduced into the cross member through the first opening is discharged from the communicating portion, the gas is discharged upward from the upper wall portion. Thus, blowing of the gas discharged from the communicating portion against the first power storage cell and the second power storage cell can be suppressed and an increase in temperature of the first power storage cell and the second power storage cell can be suppressed.

The power storage device according to the present disclosure may include: a first power storage module in which a plurality of the first power storage cells are arranged in the second direction; and a second power storage module in which a plurality of the second power storage cells are arranged in the second direction. The cross member may be disposed between the first power storage module and the second power storage module. A length of the communicating portion in the second direction may be equal to or longer than a length in the second direction from a first exhaust valve located on one side in the second direction, of the first exhaust valves of the plurality of the first power storage cells, to a first exhaust valve located on the other side in the second direction, of the first exhaust valves of the plurality of the first power storage cells.

According to the above-described configuration, the communicating portion is provided over a wide range. Therefore, even when the emission is discharged from the first exhaust valve of the arbitrary first power storage cell included in the first power storage module, the gas included in the emission introduced into the cross member through the first opening can be stably discharged from the communicating portion. Thus, an excessive increase in internal pressure of the cross member can be suppressed.

The power storage device according to the present disclosure may further include: a third power storage cell disposed on a side opposite to a side where the second power storage cell is located, with respect to the first power storage cell in the first direction; and a cooler disposed in a gap between the first power storage cell and the third power storage cell to cool the first power storage cell and the third power storage cell.

According to the above-described configuration, even when the heat is transmitted from the second power storage cell to the first power storage cell, the first power storage cell can be cooled by the cooler and transmission of the heat to the third power storage cell can be suppressed by the cooler disposed between the first power storage cell and the third power storage cell.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view of a vehicle including a power storage device according to a first embodiment.

FIG. 2 shows a state in which the power storage device according to the first embodiment is fixed to the vehicle.

FIG. 3 is a plan view showing an inside of the power storage device according to the first embodiment.

FIG. 4 is a cross-sectional view taken along line IV-IV shown in FIG. 3.

FIG. 5 is a plan view of a heat insulating member that covers an opening of a cross member in the power storage device according to the first embodiment.

FIG. 6 is a schematic cross-sectional view showing movement of an emission discharged from a second power storage cell in the power storage device according to the first embodiment.

FIG. 7 is a cross-sectional view showing a cross member and a surrounding structure thereof according to a first modification.

FIG. 8 is a cross-sectional view showing a cross member and a surrounding structure thereof according to a second modification.

FIG. 9 is an exploded perspective view of a power storage device according to a second embodiment.

FIG. 10 is a plan view showing an inside of the power storage device according to the second embodiment.

### DESCRIPTION OF THE PREFERRED EMBODIMENTS

Hereinafter, embodiments of the present disclosure will be described in detail with reference to the drawings. In the embodiments described below, the same or corresponding portions are denoted by the same reference characters in the drawings, and description thereof will not be repeated.

When the number, an amount, or the like is mentioned in an embodiment and modification described below, the scope of the present disclosure is not necessarily limited to the number, the amount, or the like unless otherwise specified. Each constituent element in the embodiment and modification below is not necessarily essential to the present disclosure unless otherwise specified. When there are a plurality of embodiments and modifications below, combination of features in the embodiments and modifications as appropriate is originally intended unless otherwise specified.

### First Embodiment

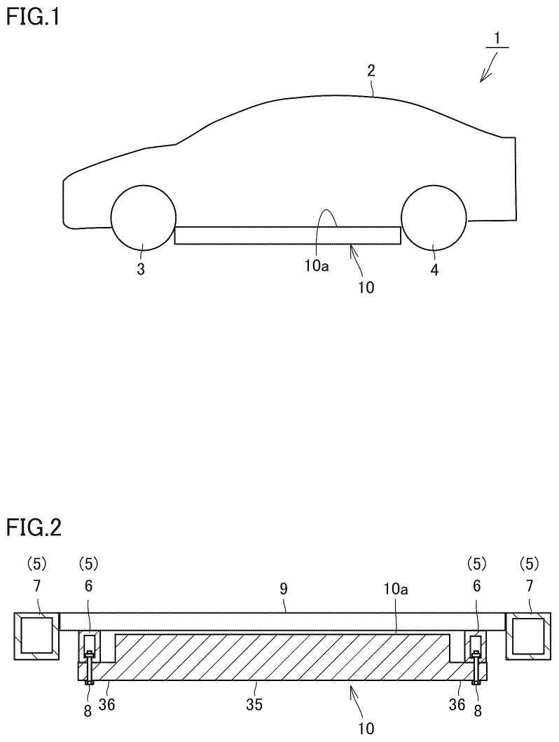

FIG. 1 is a schematic view of a vehicle including a power storage device according to a first embodiment. FIG. 2 shows a state in which the power storage device according to the first embodiment is fixed to the vehicle. A vehicle 1 according to the first embodiment will be described with reference to FIGS. 1 and 2.

Vehicle 1 is a hybrid vehicle that can travel using motive power of at least one of a motor and an engine, or an electrically powered vehicle that travels using driving force obtained by electrical energy.

Vehicle 1 includes a vehicle main body 2, a front wheel 3, a rear wheel 4, and a power storage device 10. Vehicle main body 2 includes a frame member 5. Power storage device 10 is disposed below vehicle main body 2. Power storage device 10 is disposed between front wheel 3 and rear wheel 4, for example. A part of power storage device 10 may be disposed to overlap with at least one of front wheel 3 and rear wheel 4 when viewed in a width direction of vehicle 1. Power storage device 10 has an upper surface 10a. Upper surface 10a may function as a floor member that defines a vehicle interior.

Frame member 5 includes a pair of side members 6 and a pair of side sills 7.

The pair of side sills 7 are disposed at both ends in the width direction of vehicle 1. The pair of side members 6 are disposed inside the pair of side sills 7 with a distance therebetween. The pair of side members 6 and the pair of side sills 7 extend along a front-rear direction of vehicle 1.

The pair of side members 6 are spaced apart from each other in the width direction of vehicle 1. A main body portion 35 of power storage device 10 is disposed in a gap between the pair of side members 6. A void space is provided between main body portion 35 and the pair of side members 6. As a result, even when vehicle 1 experiences side collision, input of the impact to power storage device 10 can be suppressed.

Fixed portions 36 are provided on both side surfaces of main body portion 35 in the width direction of vehicle 1. Fixed portions 36 are fixed to the pair of side members 6 by fastening members 8, respectively.

Frame member 5 also includes a cross frame member 9. Cross frame member 9 is provided above power storage device 10 to extend from one side sill 7 to the other side sill 7. Upper surface 10a of power storage device 10 is fixed to cross frame member 9.

Although the example in which frame member 5 includes the pair of side members 6 and the pair of side sills 7 has been illustrated and described above, the present disclosure is not limited thereto. The pair of side sills 7 may have the function of the pair of side members 6. In this case, the pair of side members 6 can be omitted and fixed portions 36 described above may be fixed to the pair of side sills 7.

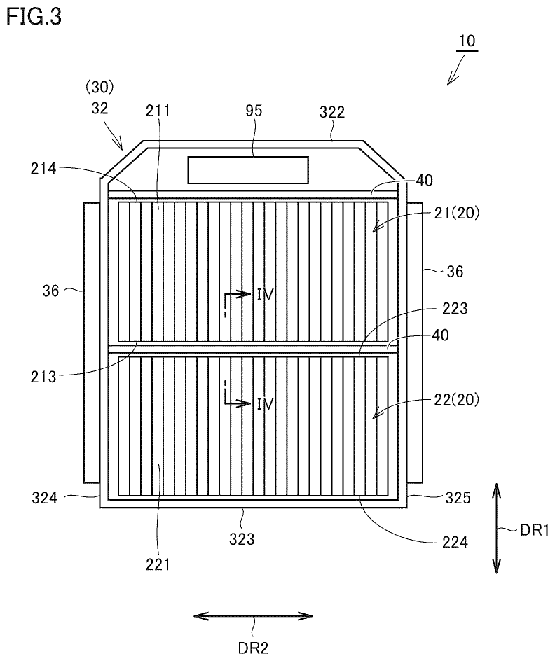

FIG. 3 is a plan view showing an inside of the power storage device according to the first embodiment. Details of power storage device 10 will be described with reference to FIG. 3.

As shown in FIG. 3, power storage device 10 includes a plurality of power storage modules 20, an accommodation case 30, a plurality of cross members 40, and an electronic device 95.

The plurality of power storage modules 20 include a first power storage module 21 and a second power storage module 22. First power storage module 21 and second power storage module 22 are spaced apart from each other in a first direction (DR1 direction). In the present embodiment, the first direction is, for example, parallel to the front-rear direction of vehicle 1 in a mounted state in which power storage device 10 is mounted on vehicle main body 2.

First power storage module 21 includes a plurality of first power storage cells 211. The plurality of first power storage cells 211 are arranged in a second direction (DR2 direction) perpendicular to the first direction. In the present embodiment, the second direction is, for example, parallel to the width direction of vehicle 1 in the above-described mounted state. Second power storage module 22 includes a plurality of second power storage cells 221. The plurality of second power storage cells 221 are disposed side by side in the second direction.

Each of first power storage cells 211 and second power storage cells 221 has an elongated shape whose longitudinal direction is the first direction. Each of first power storage cells 211 and second power storage cells 221 has a flat rectangular parallelepiped shape having a thickness in the second direction.

First power storage cells 211 and second power storage cells 221 may be configured by the same power storage cell. In this case, the number of components can be reduced, and the manufacturing cost can be reduced. It should be noted that “same” encompasses the inclusion of manufacturing errors such as tolerance. Alternatively, first power storage cells 211 and second power storage cells 221 may be configured by different power storage cells.

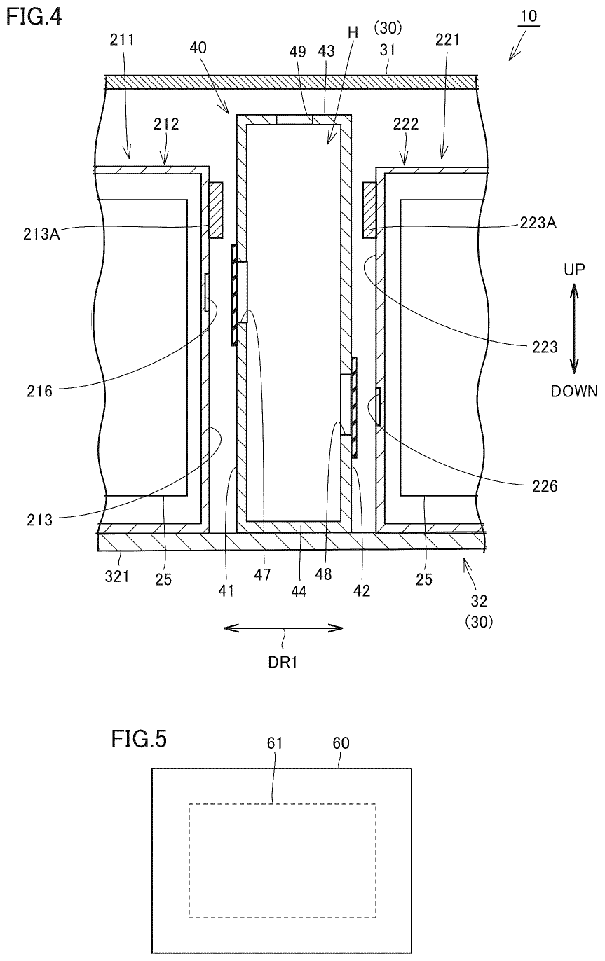

Each of first power storage cells 211 includes a housing 212 (see FIG. 4), and each of second power storage cells 221 includes a housing 222 (see FIG. 4). A single or a plurality of electrode assemblies 25 (see FIG. 4) are accommodated in each of housings 212 and 222.

When single electrode assembly 25 is accommodated in each of housings 212 and 222, the electrode assembly has a shape extending in the above-described longitudinal direction. Electrode assembly 25 may be a stacked electrode assembly in which a negative electrode sheet, a separator and a positive electrode sheet are stacked, or may be a wound electrode assembly in which a negative electrode sheet, a separator and a positive electrode sheet are wound.

When the plurality of electrode assemblies are accommodated in each of housings 212 and 222, the plurality of electrode assemblies are disposed side by side in the longitudinal direction and are connected in series. In this case as well, each of the electrode assemblies may be a stacked electrode assembly, or may be a wound electrode assembly.

Each of first power storage cells 211 and second power storage cells 221 is a secondary battery such as a nickel-metal hydride battery or a lithium ion battery. Each of first power storage cells 211 and second power storage cells 221 may be a power storage cell including a liquid electrolyte, or may be a power storage cell including a solid electrolyte. Each of first power storage cells 211 and second power storage cells 221 may be a chargeable and dischargeable capacitor.

Accommodation case 30 includes an upper member 31 (see FIG. 4) and a lower member 32 serving as a lower case. Lower member 32 has a substantially box shape that is opened upward. Lower member 32 includes main body portion 35 and fixed portions 36. Main body portion 35 has a bottom wall portion 321, a front wall portion 322, a rear wall portion 323, and side wall portions 324 and 325. Front wall portion 322, rear wall portion 323, and side wall portions 324 and 325 are provided to rise from a perimeter edge of bottom wall portion 321.

Front wall portion 322 and rear wall portion 323 face each other in the first direction. Side wall portions 324 and 325 face each other in the second direction. Fixed portions 36 are provided on outer surfaces of side wall portions 324 and 325.

The plurality of cross members 40 are fixed to above-described lower member 32. The plurality of cross members 40 are provided to partition an accommodation space in accommodation case 30. Specifically, cross members 40 are provided to extend in the second direction. In the present embodiment, the accommodation space in accommodation case 30 is divided into three regions in the first direction by two cross members 40.

In the three divided regions, electronic device 95, first power storage module 21 and second power storage module 22 are disposed in this order from one side in the first direction. Cross member 40 is disposed in a gap between electronic device 95 and first power storage module 21, and cross member 40 is disposed in a gap between first power storage module 21 and second power storage module 22.

The number of cross members 40 is not limited to two, and may be one or three or more as long as cross member 40 is disposed in a gap between first power storage module 21 and second power storage module 22 adjacent to each other. Cross member 40 is made of, for example, a metal member such as SUS.

At least the cross member disposed in the gap between first power storage module 21 and second power storage module 22, of the plurality of cross members 40, is provided with a hollow portion H (see FIG. 4). All of the plurality of cross members 40 may be provided with hollow portions H. Hollow portion H may constitute a part of a smoke discharge path of a gas discharged when any one of the power storage cells included in first power storage module 21 and second power storage module 22 generates heat.

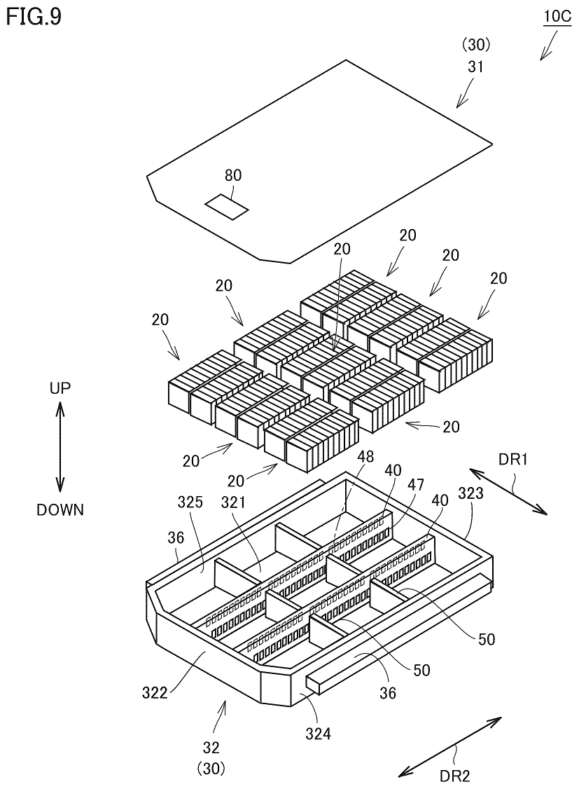

Upper member 31 covers the plurality of power storage modules 20 and closes an open space of lower member 32. A sealing member may be filled into a gap between upper member 31 and power storage modules 20. The sealing member may have insulating properties. Upper member 31 has a substantially flat plate shape, for example. The shape of upper member 31 is not limited to the flat plate shape, and may be a substantially box shape that is opened downward. Upper member 31 may also be provided with a discharge portion 80 (see FIG. 9) for discharging the gas inside accommodation case 30 when an internal pressure in accommodation case 30 becomes higher than a predetermined pressure. When discharge portion 80 is provided, vehicle 1 has a structure that prevents the gas discharged from discharge portion 80 from being introduced into the interior of vehicle 1.

Electronic device 95 controls the plurality of power storage modules 20. Electronic device 95 is a battery ECU, for example.

FIG. 4 is a cross-sectional view taken along line IV-IV shown in FIG. 3, and more particularly, is a cross-sectional view showing the cross member and a surrounding structure thereof. For the sake of convenience, FIG. 4 also shows the upper member of accommodation case 30. Details of cross member 40 and the surrounding structure thereof will be described with reference to FIG. 4.

As described above, cross member 40 is provided with hollow portion H in a cross section perpendicular to the second direction. Hollow portion H is provided to continuously extend in the second direction. Cross member 40 is also provided with a first opening 47, a second opening 48 and a communicating portion 49. Cross member 40 includes a first wall portion 41, a second wall portion 42, an upper wall portion 43, and a bottom wall portion 44.

First wall portion 41 is located on one side in the first direction. First wall portion 41 faces first power storage cell 211 in the first direction. First wall portion 41 is provided with first opening 47. First opening 47 is provided to face first power storage cell 211. More particularly, first opening 47 is disposed to face a first exhaust valve 216 described below. A plurality of first openings 47 are provided side by side in the second direction and the plurality of first openings 47 face power storage cells 211, respectively.

Second wall portion 42 is located on the other side in the first direction. Second wall portion 42 faces second power storage cell 221 in the first direction. Second wall portion 42 is provided with second opening 48. Second opening 48 is provided to face second power storage cell 221. More particularly, second opening 48 is disposed to face a second exhaust valve 226 described below. A plurality of second openings 48 are provided side by side in the second direction and the plurality of second openings 48 face power storage cells 221, respectively.

Above-described first opening 47 and second opening 48 are disposed to be displaced in a vertical direction (up-down direction) perpendicular to the first direction and the second direction, when viewed in the first direction. Specifically, for example, first opening 47 is located above second opening 48 when viewed in the first direction. First opening 47 may be located below second opening 48 when viewed in the first direction.

First opening 47 is covered with a heat insulating member 60 described below. Second opening 48 is covered with heat insulating member 60.

A height of first wall portion 41 and second wall portion 42 in the vertical direction is higher than a height of first power storage cell 211 and second power storage cell 221. The above-described height of first wall portion 41 and second wall portion 42 may be the same as the height of first power storage cell 211 and second power storage cell 221.

Upper wall portion 43 and bottom wall portion 44 face each other in the vertical direction. Upper wall portion 43 connects upper ends of first wall portion 41 and second wall portion 42 to each other. Bottom wall portion 44 connects lower ends of first wall portion 41 and second wall portion 42 to each other. Bottom wall portion 44 functions as a bottom surface defining portion that defines a bottom surface of hollow portion H. Bottom wall portion 44 is fixed to bottom wall portion 321 of accommodation case 30.

Communicating portion 49 is provided at a position where communicating portion 49 does not face first exhaust valve 216 in cross member 40. In the present embodiment, communicating portion 49 is provided in upper wall portion 43.

Communicating portion 49 allows hollow portion H and a space around cross member 40 to communicate with each other. More particularly, communicating portion 49 allows hollow portion H and a space in accommodation case 30 to communicate with each other. Communicating portion 49 extends along the second direction.

Cross member 40 has a first end portion and a second end portion at both ends in the second direction. Communicating portion 49 continuously extends from the first end portion side to the second end portion side. A length of communicating portion 49 in the second direction is, for example, equal to or longer than a length in the second direction from a first exhaust valve located on one side in the second direction, of first exhaust valves 216 of the plurality of first power storage cells 211 in first power storage module 21, to first exhaust valve 216 located on the other side in the second direction, of above-described first exhaust valves 216.

Communicating portion 49 may have a shape extending in the second direction intermittently to correspond to power storage modules 20 disposed side by side in the second direction.

Above-described housing 212 of first power storage cell 211 has a first side wall portion 213 facing first wall portion 41 in the first direction. First side wall portion 213 is provided with an external terminal 213A and first exhaust valve 216.

First exhaust valve 216 is a valve for discharging an emission from inside first power storage cell 211. The emission includes a gas. The emission may include a foreign substance such as an electrolyte or a metal foreign substance. First exhaust valve 216 functions as a pressure relief valve. First exhaust valve 216 is provided to be broken when an internal pressure of housing 212 becomes equal to or higher than a predetermined pressure. First exhaust valve 216 faces cross member 40 (more particularly, first wall portion 41) in the first direction.

External terminal 213A is, for example, disposed above first exhaust valve 216. External terminal 213A faces first wall portion 41 in the first direction.

Above-described housing 222 of second power storage cell 221 has a second side wall portion 223 facing second wall portion 42 in the first direction. Second side wall portion 223 is provided with an external terminal 223A and second exhaust valve 226.

Second exhaust valve 226 is a valve for discharging the above-described emission from inside second power storage cell 221. Second exhaust valve 226 functions as a pressure relief valve. Second exhaust valve 226 is provided to be broken when an internal pressure of housing 222 becomes equal to or higher than a predetermined pressure. Second exhaust valve 226 faces cross member 40 (more particularly, second wall portion 42) in the first direction.

External terminal 223A is, for example, disposed above second exhaust valve 226. External terminal 223A faces second wall portion 42 in the first direction.

Above-described first exhaust valve 216 and second exhaust valve 226 are disposed to be displaced in the vertical direction when viewed in the first direction. Specifically, first exhaust valve 216 is, for example, provided above a central portion of first side wall portion 213 in the vertical direction. Second exhaust valve 226 is, for example, provided below a central portion of second side wall portion 223 in the vertical direction.

FIG. 5 is a plan view of the heat insulating member that covers the opening of the cross member in the power storage device according to the first embodiment.

As shown in FIG. 5, heat insulating member 60 is provided to have a sheet shape. Heat insulating member 60 is made of a mica sheet, for example. Heat insulating member 60 is provided to be breakable. More particularly, heat insulating member 60 is provided with an easily breakable portion 61.

Easily breakable portion 61 is configured by a breaking line, for example. The breaking line is formed by through holes arranged in a ring shape or in a frame shape. First exhaust valve 216 or second exhaust valve 226 faces, in the first direction, the region of heat insulating member 60 surrounded by the breaking line.

Heat insulating member 60 is not limited to the mica sheet, and may be made of a heat insulating resin sheet that is lower in strength than the mica sheet. In this case, easily breakable portion 61 may be omitted.

Heat insulating member 60 facing first exhaust valve 216 is configured to be breakable by the emission discharged from first exhaust valve 216. When the emission is not discharged from first exhaust valve 216 and the emission is discharged from second exhaust valve 226, it is preferable that heat insulating member 60 facing first exhaust valve 216 should not be broken by the emission discharged from second exhaust valve 226.

Similarly, heat insulating member 60 facing second exhaust valve 226 is configured to be breakable by the emission discharged from second exhaust valve 226. When the emission is not discharged from second exhaust valve 226 and the emission is discharged from first exhaust valve 216, it is preferable that heat insulating member 60 facing second exhaust valve 226 should not be broken by the gas discharged from first exhaust valve 216.

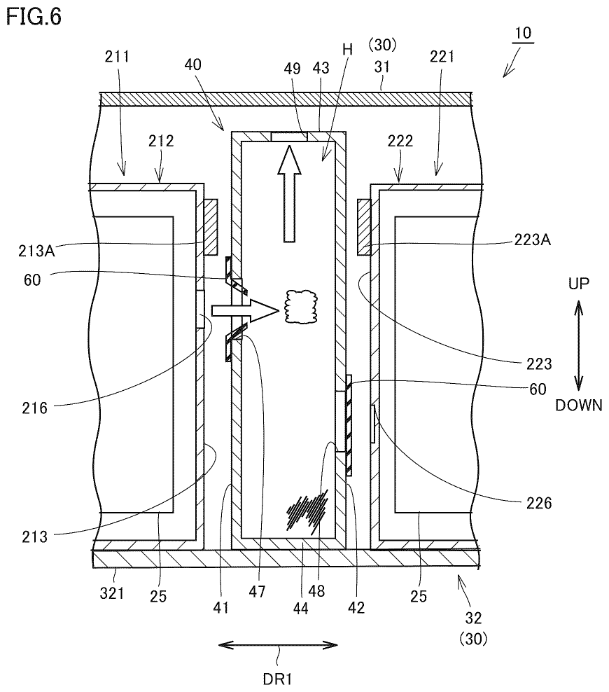

FIG. 6 is a schematic cross-sectional view showing movement of the emission discharged from the second power storage cell in the power storage device according to the first embodiment.

As shown in FIG. 6, when the emission is discharged from first exhaust valve 216 of first power storage cell 211, heat insulating member 60 facing this first exhaust valve 216 is broken, whereby the emission is introduced into cross member 40 through first opening 47. Since heat insulating member 60 is provided with easily breakable portion 61, heat insulating member 60 is easily broken by the momentum of the emission. In addition, since first exhaust valve 216 faces the region surrounded by the breaking line that constitutes easily breakable portion 61, heat insulating member 60 can be broken more reliably.

Since the emission is introduced into cross member 40, the emission can be collected inside the cross member (hollow portion H). Particularly, a substance heavier than air, which is included in the emission, is accumulated on bottom wall portion 44. Thus, it is possible to suppress scattering of the emission discharged from first power storage cell 211 having generated heat to a space around first power storage cell 211 and thus a region where first power storage module 21 is accommodated.

Furthermore, since first opening 47 and first exhaust valve 216 face each other in the first direction, the emission is discharged directly to first opening 47 from first exhaust valve 216. Therefore, diffusion of the emission to the surroundings of first power storage module 21 can be suppressed and the emission can be directly introduced into cross member 40. Thus, scattering of the emission can be further suppressed.

In addition, the gas included in the emission introduced into cross member 40 through first opening 47 is discharged to a space (in accommodation case 30) around cross member 40 from communicating portion 49 provided at the position where communicating portion 49 does not face first exhaust valve 216. Thus, an excessive increase in internal pressure of cross member 40 caused by the gas introduced into cross member 40 through first opening 47 can be suppressed.

Generally, when the internal pressure of cross member 40 increases excessively, there is a concern that a part of cross member 40 may be deformed or broken and the gas may be jetted from an unintended location and the emission collected inside the cross member may be blown out.

In the present embodiment, communicating portion 49 is provided as described above. Therefore, the excessive increase in internal pressure of cross member 40 can be suppressed and the above-described blowout of the emission from the unintended location can be suppressed. This also makes it possible to suppress scattering of the emission discharged from first power storage cell 211 having generated the heat.

Since communicating portion 49 is provided in upper wall portion 43 of cross member 40, the gas in cross member 40 can be discharged upward. Thus, blowing of the gas discharged from communicating portion 49 directly against power storage module 20 (first power storage cell 211 and second power storage cell 221) can be suppressed. As a result, an increase in temperature of power storage module 20 caused by the gas discharged from communicating portion 49 can be suppressed. A gap is provided between upper wall portion 43 and upper member 31, and the gas is discharged toward the gap.

In addition, the length of communicating portion 49 is equal to or longer than the length in the second direction from first exhaust valve 216 located on one side in the second direction, of first exhaust valves 216 of the plurality of first power storage cells 211, to first exhaust valve 216 located on the other side in the second direction, of above-described first exhaust valves 216. Thus, even when the emission is discharged from first exhaust valve 216 of arbitrary first power storage cell 211 included in first power storage module 21, the gas included in the emission introduced into cross member 40 through first opening 47 can be stably discharged from communicating portion 49. As a result, the excessive increase in internal pressure of the cross member can be further suppressed.

In addition, as described above, second opening 48 located opposite to first opening 47 is covered with heat insulating member 60. Therefore, transmission of the heat from second opening 48 to second power storage cell 221 can be suppressed by heat insulating member 60. Thus, an increase in temperature of second power storage cell 221 and thus second power storage module 22 can be suppressed.

Furthermore, since first opening 47 and second opening 48 are disposed to be displaced in the vertical direction when viewed in the first direction, a flow of the emission introduced through first opening 47 directly to second opening 48 can be suppressed. Thus, an increase in temperature of second power storage cell 221 and thus second power storage module 22 can be suppressed.

Although the example in which the emission is discharged from first power storage cell 211 has been described above, an effect that is substantially the same as the above can also be obtained when the emission is discharged from second power storage cell 221. For example, when the gas is discharged from second power storage cell 221, heat insulating member 60 that covers second opening 48 is broken and the emission can be introduced into cross member 40 through second opening 48. Thus, the emission can be retained in cross member 40 and scattering of the emission within accommodation case 30 can be prevented.

In addition, since first opening 47 located opposite to second opening 48 is covered with heat insulating member 60, transmission of the heat from first opening 47 to first power storage cell 211 can be suppressed. Furthermore, since second opening 48 is displaced from first opening 47 in the vertical direction when viewed in the first direction, a flow of the emission introduced into cross member 40 through second opening 48 directly to first opening 47 can be suppressed. An effect produced by discharge of the gas from communicating portion 49 is the same as the above.

### First Modification

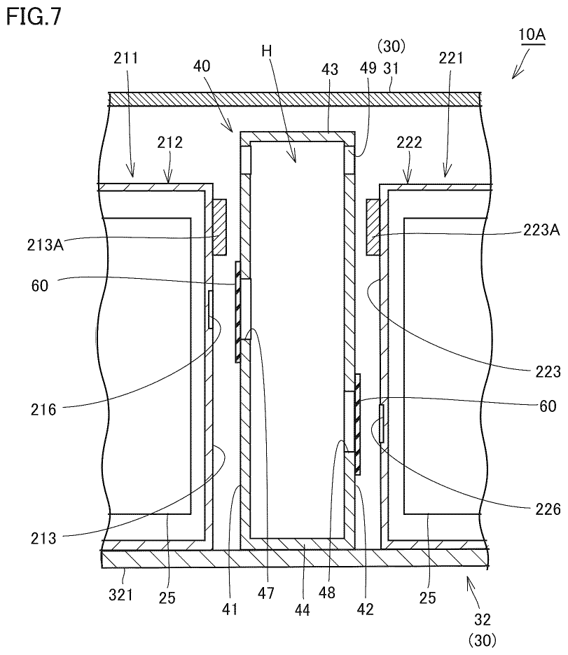

FIG. 7 is a cross-sectional view showing a cross member and a surrounding structure thereof according to a first modification. A power storage device 10A according to the first modification will be described with reference to FIG. 7.

As shown in FIG. 7, power storage device 10A according to the first modification is different from power storage device 10 according to the first embodiment in terms of the position of communicating portions 49 provided in cross member 40. Power storage device 10A according to the first modification is otherwise substantially the same as power storage device 10 according to the first embodiment.

In the first modification, a height of cross member 40 in the vertical direction is higher than a height of first power storage cell 211 and second power storage cell 221 in the vertical direction, and communicating portions 49 are provided above first power storage cell 211 and second power storage cell 221.

Specifically, communicating portions 49 are provided in portions of first wall portion 41 and second wall portion 42 located above first power storage cell 211 and second power storage cell 221. Communicating portion 49 may be provided in any one of first wall portion 41 and second wall portion 42.

With the above-described configuration as well, power storage device 10A according to the first modification can obtain substantially the same effect as that of power storage device 10 according to the first embodiment. In addition, in the case where cross member 40 in the first modification is adopted, the gas can be effectively discharged toward a space located above first power storage cell 211 and second power storage cell 221 when there is no sufficient gap between upper wall portion 43 of cross member 40 and upper member 31.

### Second Modification

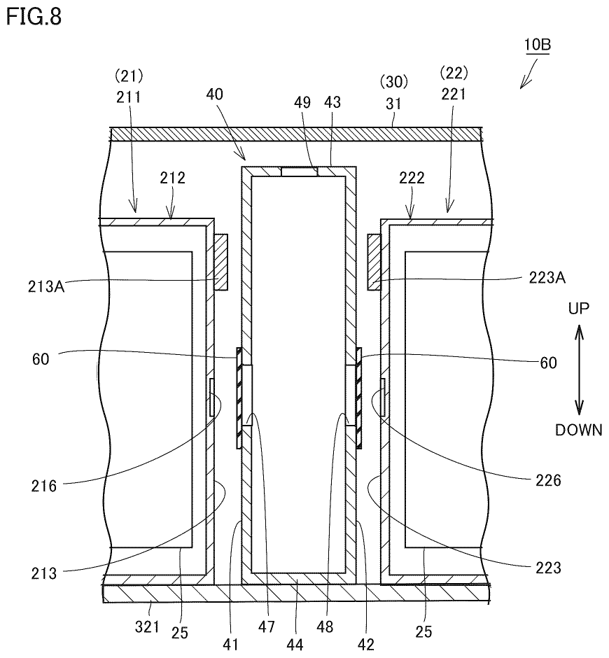

FIG. 8 is a cross-sectional view showing a cross member and a surrounding structure thereof according to a second modification. A power storage device 10B according to the second modification will be described with reference to FIG. 8.

As shown in FIG. 8, power storage device 10B according to the second modification is different from power storage device 10 according to the first embodiment in terms of the position of first opening 47 and second opening 48 provided in cross member 40 and the position of first exhaust valve 216 and second exhaust valve 226. Power storage device 10B according to the second modification is otherwise substantially the same as power storage device 10 according to the first embodiment.

In the second modification, first opening 47 and second opening 48 are disposed to overlap with each other when viewed in the first direction. In addition, first exhaust valve 216 and second exhaust valve 226 are also disposed to overlap with each other when viewed in the first direction. First exhaust valve 216 is, for example, provided in the central portion of first side wall portion 213 in the vertical direction. Second exhaust valve 226 is, for example, provided in the central portion of second side wall portion 223 in the vertical direction.

With the above-described configuration as well, power storage device 10B according to the second modification can obtain substantially the same effect as that of power storage device 10 according to the first embodiment. In the second modification, when the emission is introduced into cross member 40 through one opening of first opening 47 and second opening 48, the emission flows directly to the other opening of first opening 47 and second opening 48. However, the momentum of the emission is suppressed by heat insulating member 60 provided at one opening and heat insulating member 60 provided at the other opening. Thus, an influence of the heat on the power storage cell located on the other opening side can be suppressed.

### Second Embodiment

FIG. 9 is an exploded perspective view of a power storage device according to a second embodiment. A power storage device 10C according to the second embodiment will be described with reference to FIG. 9.

Power storage device 10C according to the second embodiment is different from power storage device 10 according to the first embodiment mainly in terms of the arrangement and structure of the plurality of power storage modules 20 and cross members 40, and the presence of partition walls 50. Power storage device 10C according to the second embodiment is otherwise substantially the same as power storage device 10 according to the first embodiment.

In the second embodiment, the first direction is parallel to the width direction of vehicle 1 and the second direction is parallel to the front-rear direction of vehicle 1 in the mounted state in which power storage device 10C is mounted on vehicle main body 2.

The plurality of power storage modules 20 are disposed in a matrix shape in the first direction and the second direction. In accommodation case 30, a region where power storage modules 20 are disposed is partitioned by the plurality of cross members 40 and the plurality of partition walls 50.

Cross members 40 are spaced apart from each other and disposed side by side in the first direction. Each of cross members 40 is disposed in a gap between power storage modules 20 adjacent to each other in the first direction. Each of cross members 40 extends in the second direction. Each of cross members 40 extends from front wall portion 322 to rear wall portion 323 of lower member 32 of accommodation case 30.

Partition walls 50 partition the space in accommodation case 30 divided by cross members 40, to correspond to the number of the plurality of power storage modules 20. Each of partition walls 50 extends in the first direction. Each of partition walls 50 may have a hollow structure.

Discharge portion 80 is provided in upper member 31 of accommodation case 30. Discharge portion 80 discharges the gas inside accommodation case 30 when the internal pressure in accommodation case 30 becomes higher than a predetermined pressure. Specifically, the gas included in the emission is discharged into accommodation case 30 from the power storage cells included in the plurality of power storage modules 20, and the gas is discharged outside accommodation case 30 when the internal pressure in accommodation case 30 becomes higher than the predetermined pressure.

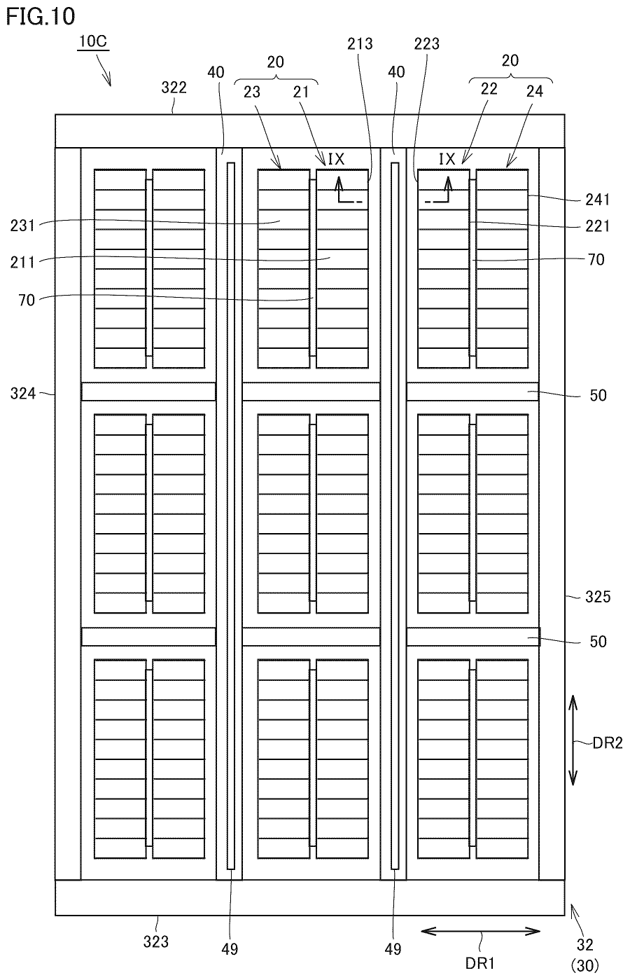

FIG. 10 is a plan view showing an inside of the power storage device according to the second embodiment. As shown in FIG. 10, power storage module 20 located on one side in the first direction, of power storage modules 20 adjacent to each other in the first direction, includes first power storage module 21 and a third power storage module 23. Power storage module 20 located on the other side in the first direction, of power storage modules 20 adjacent to each other in the first direction, includes second power storage module 22 and a fourth power storage module 24.

In above-described power storage module 20 located on one side in the first direction, first power storage module 21 and third power storage module 23 are disposed to face each other in the first direction.

First power storage module 21 has a plurality of first power storage cells 211. The plurality of first power storage cells 211 are arranged in the second direction. Each of first power storage cells 211 has a pair of side wall portions in the first direction, and first side wall portion 213 located on the closest cross member 40 side is provided with a pair of external terminals having different polarities. The side wall portion located opposite to above-described first side wall portion 213, of the above-described pair of side wall portions, is in thermal contact with a cooler 70 described below.

Third power storage module 23 is disposed on a side opposite to a side where above-described second power storage module 22 is located, with respect to first power storage module 21. Third power storage module 23 has a plurality of third power storage cells 231. The plurality of third power storage cells 231 are arranged in the second direction. Each of third power storage cells 231 is disposed on a side opposite to a side where second power storage cell 221 included in above-described second power storage module 22 is located, with respect to first power storage cell 211. Each of third power storage cells 231 includes a side wall portion on a side opposite to a side where first power storage cell 211 is located, and the side wall portion is provided with a pair of external terminals having different polarities.

In above-described power storage module 20 located on the other side in the first direction, second power storage module 22 and fourth power storage module 24 are disposed to face each other in the first direction.

Second power storage module 22 has a plurality of second power storage cells 221. The plurality of second power storage cells 221 are arranged in the second direction. Each of second power storage cells 221 has a pair of side wall portions in the first direction, and second side wall portion 223 located on the closest cross member 40 side is provided with a pair of external terminals having different polarities. The side wall portion located opposite to above-described second side wall portion 223, of the above-described pair of side wall portions, is in thermal contact with cooler 70 described below.

Fourth power storage module 24 is disposed on a side opposite to a side where above-described first power storage module 21 is located, with respect to second power storage module 22. Fourth power storage module 24 has a plurality of fourth power storage cells 241. The plurality of fourth power storage cells 241 are arranged in the second direction. Each of fourth power storage cells 241 is disposed on a side opposite to a side where first power storage cell 211 included in above-described first power storage module 21 is located, with respect to second power storage cell 221. Each of fourth power storage cells 241 includes a side wall portion on a side opposite to a side where second power storage cell 221 is located, and the side wall portion is provided with a pair of external terminals having different polarities.

First power storage cells 211, second power storage cells 221, third power storage cells 231, and fourth power storage cells 241 have substantially the same configuration. Each of first power storage cells 211, second power storage cells 221, third power storage cells 231, and fourth power storage cells 241 has a flat rectangular tube shape in the second direction.

Power storage device 10C includes cooler 70. Cooler 70 is provided in each of power storage modules 20. Cooler 70 is disposed between the power storage modules adjacent to each other in the second direction so as to cool both of the power storage modules adjacent to each other in the second direction in power storage modules 20. For example, in above-described power storage module 20 located on one side in the first direction, cooler 70 is sandwiched between first power storage module 21 and third power storage module 23 as described above. Similarly, in above-described power storage module 20 located on the other side in the first direction, cooler 70 is sandwiched between second power storage module 22 and fourth power storage module 24 as described above. Cooler 70 has therein a refrigerant flow path through which a cooling medium flows.

Cross member 40 has a first end portion and a second end portion at both ends in the second direction. Communicating portion 49 continuously extends from the first end portion side to the second end portion side.

Communicating portion 49 may have a shape extending in the second direction intermittently to correspond to power storage modules 20 disposed side by side in the second direction. In this case, at a location corresponding to each power storage module 20 (specifically, a portion of cross member 40 facing each power storage module 20), a length of communicating portion 49 in the second direction may be, for example, equal to or longer than a length in the second direction from first exhaust valve 216 located on one side in the second direction, of first exhaust valves 216 of the plurality of first power storage cells 211, to first exhaust valve 216 located on the other side in the second direction, of above-described first exhaust valves 216.

Cross member 40 in any one of the first embodiment, the first modification and the second modification can be adopted as cross member 40 in the second embodiment. Thus, power storage device 10C according to the second embodiment can also obtain substantially the same effect as that of the power storage device according to the first embodiment, the first modification or the second modification.

In addition, cooler 70 is provided between first power storage cell 211 and third power storage cell 231 as described above. Thus, even when the heat is transmitted from the second power storage cell 221 side to first power storage cell 211, first power storage cell 211 can be cooled by cooler 70 and transmission of the heat to third power storage cell 231 can be suppressed.

Similarly, cooler 70 is provided between second power storage cell 221 and fourth power storage cell 241. Thus, even when the heat is transmitted from the first power storage cell 211 side to second power storage cell 221, second power storage cell 221 can be cooled by cooler 70 and transmission of the heat to fourth power storage cell 241 can be suppressed.

### Other Modifications

Although the example in which first exhaust valve 216 faces first opening 47 and second exhaust valve 226 faces second opening 48 has been illustrated and described in the first and second embodiments, first modification and second modification above, the present disclosure is not limited thereto. First exhaust valve 216 does not necessarily need to face first opening 47 as long as first exhaust valve 216 faces first side wall portion 213, and second exhaust valve 226 does not necessarily need to face second opening 48 as long as second exhaust valve 226 faces second side wall portion 223.

In this case as well, when the emission is discharged from one exhaust valve of first exhaust valve 216 and second exhaust valve 226, the emission can be introduced into cross member 40 through the opening closer to this one exhaust valve, of the first opening and the second opening. Thus, the emission can be collected inside cross member 40.

Although the example in which first opening 47 and second opening 48 are provided with heat insulating members 60 has been illustrated and described in the first and second embodiments, first modification and second modification above, the present disclosure is not limited thereto. Heat insulating members 60 may be omitted.

Although the example in which cross member 40 has bottom wall portion 44 has been illustrated in the first and second embodiments, first modification and second modification above, the present disclosure is not limited thereto. Bottom wall portion 44 may be omitted. In this case, a flange portion may be provided to extend outward from a lower end of each of first wall portion 41 and second wall portion 42, and the flange portion may be fixed to bottom wall portion 321 of accommodation case 30. In this case, a portion of bottom wall portion 321 of accommodation case 30 facing upper wall portion 43 in the up-down direction functions as a bottom surface defining portion that defines the bottom surface of hollow portion H.

Although the example in which communicating portion 49 is provided above upper wall portion 43 or first power storage cell 211 and second power storage cell 222 has been illustrated in the first and second embodiments, first modification and second modification above, communicating portion 49 may be provided above first exhaust valve 216 and second exhaust valve 226.

Although the embodiments of the present disclosure have been described, it should be understood that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. A power storage device comprising:
a first power storage cell and a second power storage cell spaced apart from each other and disposed side by side in a first direction; and
a cross member extending along a second direction perpendicular to the first direction and disposed in a gap between the first power storage cell and the second power storage cell, wherein
the first power storage cell includes a first side wall portion facing the cross member,
the first side wall portion is provided with a first exhaust valve,
the cross member is provided with a hollow portion in a cross section perpendicular to the second direction, and is provided with a first opening such that the first opening faces the first side wall portion,
the cross member is provided with a communicating portion that allows the hollow portion and a space around the cross member to communicate with each other, and
the communicating portion is provided at a position where the communicating portion does not face the first exhaust valve.

2. The power storage device according to claim 1, wherein
the first opening is disposed to face the first exhaust valve.

3. The power storage device according to claim 2, wherein
the second power storage cell includes a second side wall portion facing the cross member,
the second side wall portion is provided with a second exhaust valve, and
the cross member is provided with a second opening such that the second opening faces the second side wall portion.

4. The power storage device according to claim 3, wherein
the first opening and the second opening are covered with a heat insulating member provided to be breakable.

5. The power storage device according to claim 4, wherein
the heat insulating member is provided with an easily breakable portion.

6. The power storage device according to claim 3, wherein
the first opening and the second opening are disposed to be displaced in a vertical direction perpendicular to the first direction and the second direction, when viewed in the first direction.

7. The power storage device according to claim 1, wherein
the communicating portion is provided above the first exhaust valve in a vertical direction perpendicular to the first direction and the second direction.

8. The power storage device according to claim 7, wherein
a height of the cross member in the vertical direction is higher than a height of the first power storage cell and the second power storage cell in the vertical direction, and
the communicating portion is provided above the first power storage cell and the second power storage cell.

9. The power storage device according to claim 7, wherein
the cross member includes an upper wall portion on an upper side in the vertical direction, and
the communicating portion is provided in the upper wall portion.

10. The power storage device according to claim 1, comprising:
a first power storage module in which a plurality of the first power storage cells are arranged in the second direction; and
a second power storage module in which a plurality of the second power storage cells are arranged in the second direction, wherein
the cross member is disposed between the first power storage module and the second power storage module, and
a length of the communicating portion in the second direction is equal to or longer than a length in the second direction from a first exhaust valve located on one side in the second direction, of the first exhaust valves of the plurality of the first power storage cells, to a first exhaust valve located on the other side in the second direction, of the first exhaust valves of the plurality of the first power storage cells.

11. The power storage device according to claim 1, further comprising:
a third power storage cell disposed on a side opposite to a side where the second power storage cell is located, with respect to the first power storage cell in the first direction; and
a cooler disposed in a gap between the first power storage cell and the third power storage cell to cool the first power storage cell and the third power storage cell.
